(19) United States
(12) Patent Application Publication
(10) Pub. No.: US 2026/0200046 A1
(43) Pub. Date: Jul. 16, 2026

(54) Rim Bolt Socket

(71) Applicant: I-N-B INTERNATIONAL INCORPORATION, Taichung City (TW)

(72) Inventor: Yi-Hung Lin, Taichung City (TW)

(21) Appl. No.: 19/020,059

(22) Filed: Jan. 14, 2025

(51) Int. Cl. B25B 13/06

(52) U.S. Cl. CPC B25B 13/06

(57) ABSTRACT

A rim bolt socket comprises a body and a protective ring. The body is provided with a protective section, a working section connected to the protective section, and a driving section connected to the working section. A connection between an outer peripheral wall of the protective section and an outer peripheral wall of the working section is formed with a first step, and a first combination part is formed on the outer peripheral wall of the protective section. The protective ring is sleeved on the protective section of the body, a second combination part is formed on an inner peripheral wall of the protective ring to be combined with the first combination part, and a first stopper is provided at one end of the protective ring to butt against the first step.

### FIELD OF THE INVENTION

The invention relates to a socket, more particularly to a rim bolt socket.

### DESCRIPTION OF THE RELATED ART

Generally, rim bolts are tightened or loosened through sockets. However, during the disassembly and assembly process, the socket will inevitably collide with the rim and damage the rim. There are even cases where the surface of the rim is processed with baking paint or spray painting, and the paint surface is directly scratched off by the socket. These damages will affect the exterior of the rim aesthetically.

Please refer to FIG. 1. In order to cope with the above problem, a sheath 92 is sleeved on a peripheral wall 91 of a socket 90. Although a rim can be prevented from being damaged by the socket 90, in order to install the sheath 92, the socket 90 must sacrifice a thickness of a large area of the peripheral wall 91, resulting in insufficient torsion bearing capacity of the socket 90 and a significant reduction in load bearing capacity. At this time, under an impact of a hand tool (such as a pneumatic wrench), the socket 90 is prone to cracks and result in ruptures from the weakened peripheral wall 91 at the expense of thickness.

### SUMMARY OF THE INVENTION

An object of the invention is to provide a rim bolt socket to solve the above difficulties mentioned in the prior art.

According to one embodiment of the invention, a rim bolt socket is provided, which comprises a body and a protective ring, wherein the body is provided with a protective section, a working section connected to the protective section, and a driving section connected to the working section, a connection between an outer peripheral wall of the protective section and an outer peripheral wall of the working section is formed with a first step, and a first combination part is formed on the outer peripheral wall of the protective section. The protective ring is sleeved on the protective section of the body, a second combination part is formed on an inner peripheral wall of the protective ring to be combined with the first combination part, and a first stopper is provided at one end of the protective ring to butt against the first step.

The rim bolt socket, wherein the body is an integrally formed metal cylinder, the body is axially provided with the protective section, the working section coaxially connected to the protective section, and the driving section coaxially connected to the working section.

The rim bolt socket, wherein a length of the protective section is less than a length of the working section, the length of the protective section is less than one-eighth of the length of the working section, an outer diameter of the protective section is less than an outer diameter of the working section, the outer diameter of the working section is less than an outer diameter of the driving section, so that a connection between the outer peripheral wall of the working section and an outer peripheral wall of the driving section is formed with a second step.

The rim bolt socket, wherein the body is provided with a first actuating part recessed on one end face of the protective section along an axial direction of the body toward the working section, the first actuating part is a hexagonal hole, the body is provided with a second actuating part recessed on one end face of the driving section along the axial direction of the body toward the working section, the second actuating part is a quadrangular hole, the first actuating part of the body is annularly provided with a plurality of first concave portions and a plurality of first convex portions on an inner peripheral wall, a first included angle is provided between any two adjacent concave surfaces of each of the first concave portions, a second included angle is provided between any two adjacent convex surfaces of each of the first convex portions, any one of the first concave portions is provided between any two of the first convex portions, two sides of any one of the first concave portions are respectively connected to one side of any two of the first convex portions, and numbers of the first concave portions and the first convex portions are equal.

The rim bolt socket, wherein the first combination part of the protective section is protruded as a convex surface or recessed as a concave surface, the second combination part of the protective ring is recessed as a concave surface or protruded as a convex surface corresponding to the first combination part, the concave surface is in the shape of a concave groove, the convex surface is in the shape of a convex arc, and the convex surface or the concave surface of the first combination part is combined with the concave surface or the convex surface of the second combination part.

The rim bolt socket, wherein the protective ring is an integrally formed ring body made of plastic or silicone.

The rim bolt socket, wherein an outer end wall of one axial end of the protective ring is protruded with the first stopper along an axial direction of the protective ring to butt against a step wall of the first step of the adjacent protective section, and the inner peripheral wall of another axial end of the protective ring is protruded with a second stopper along a radial direction of the protective ring to butt against an outer end wall of the protective section.

The rim bolt socket, wherein an outer diameter of an outer peripheral wall of one side of the first combination part of the protective section away from the working section is less than an outer diameter of an outer peripheral wall of another side of the first combination part close to the working section, thereby forming a height difference.

The rim bolt socket, wherein an inner diameter of an inner peripheral wall of one side of the second combination part of the protective ring adjacent to the first stopper is larger than an inner diameter of an inner peripheral wall of another side of the second combination part adjacent to the second stopper, thereby forming a height difference.

The rim bolt socket, wherein the first combination part is formed on the outer peripheral wall between two ends of the protective section, the second combination part is formed on the inner peripheral wall between two ends of the protective ring, an outer diameter of the protective ring and the outer diameter of the working section of the body are equal to each other, an outer peripheral wall of the protective ring and the outer peripheral wall of the working section of the body are flushed with each other.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF DRAWINGS

The above objects and advantages of the invention will become more readily apparent to those ordinarily skilled in the art after reviewing the following detailed description and accompanying drawings, in which:

FIG. 1 is an assembled cross-sectional view of a conventional rim bolt socket.

FIG. 2 is a perspective assembly view of a rim bolt socket of the invention.

FIG. 3 is a perspective assembly and partial cross-sectional view of the rim bolt socket of the invention.

FIG. 4 is a partial enlarged view of FIG. 3 of the rim bolt socket of the invention.

FIG. 5 is a perspective exploded and partial cross-sectional view of the rim bolt socket of the invention.

FIG. 6 is perspective assembly and partial cross-sectional view of FIG. 3 of the rim bolt socket of the invention from another viewing angle.

FIG. 7 is a perspective exploded and partial cross-sectional view of FIG. 5 of the rim bolt socket of the invention from another viewing angle.

FIG. 8 is a first assembled cross-sectional view of the rim bolt socket of the invention.

FIG. 9 is a partial enlarged view of FIG. 8 of the rim bolt socket of the invention.

FIG. 10 is a second assembled cross-sectional view of the rim bolt socket of the invention.

FIG. 11 is a partial enlarged view of FIG. 10 of the rim bolt socket of the invention.

FIG. 12 is a perspective exploded view of combination of the rim bolt socket and a rim bolt of the invention.

FIG. 13 is a perspective assembly and partial cross-sectional view of combination of the rim bolt socket and the rim bolt of the invention.

FIG. 14 is an assembled cross-sectional view of the rim bolt socket and the rim bolt of the invention in a first use state.

FIG. 15 is an assembled cross-sectional view of the rim bolt socket and the rim bolt of the invention in a second use state.

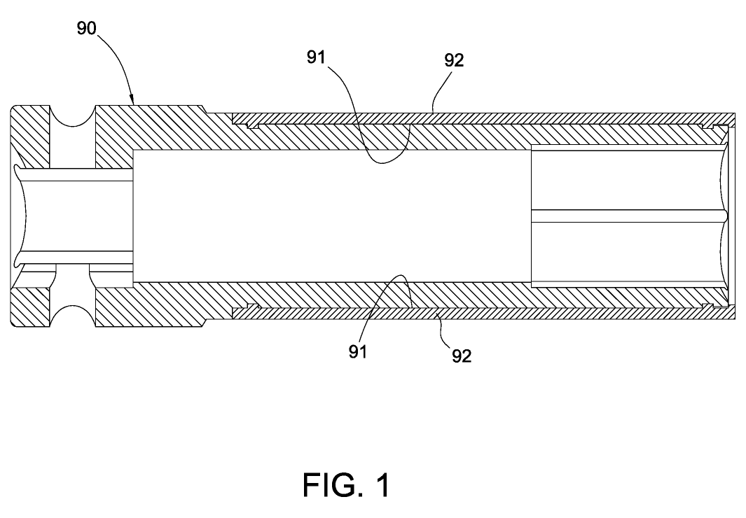

### DETAILED DESCRIPTION OF THE INVENTION

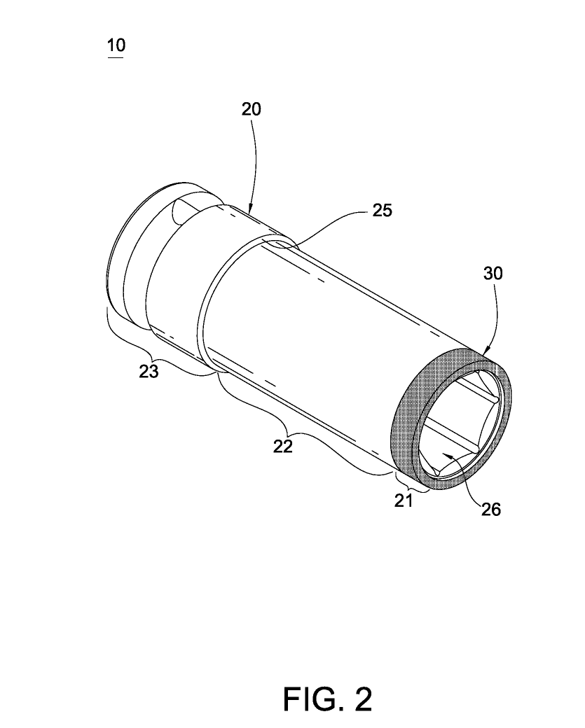

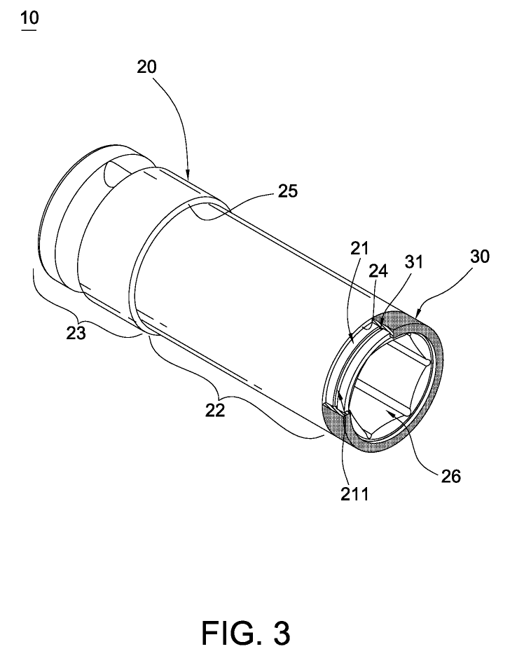

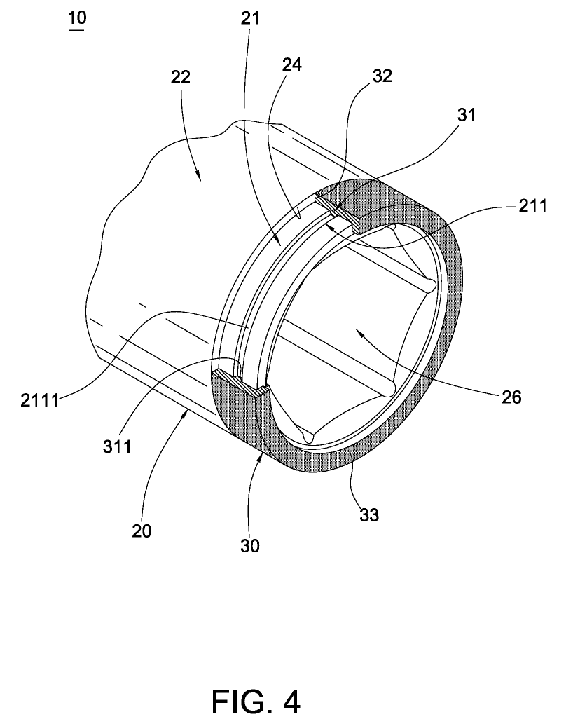

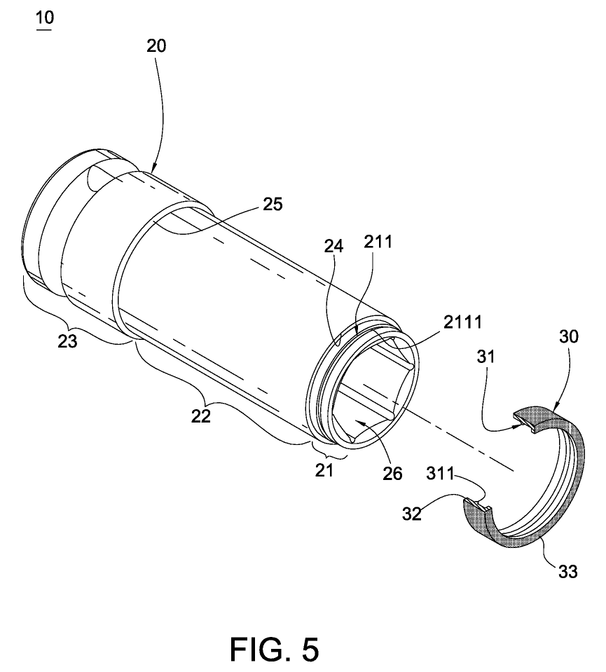

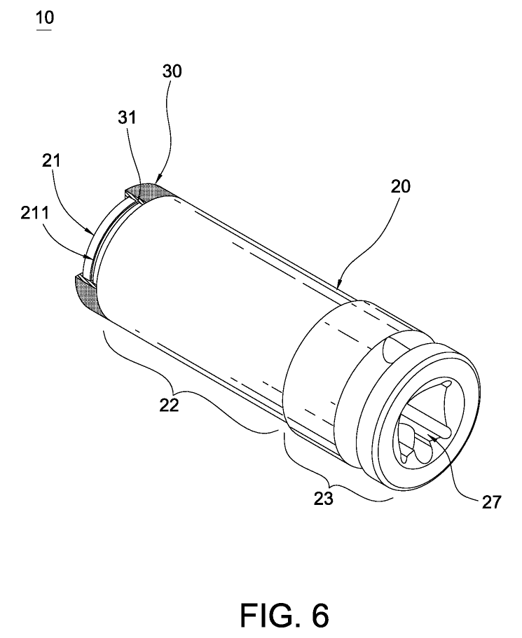

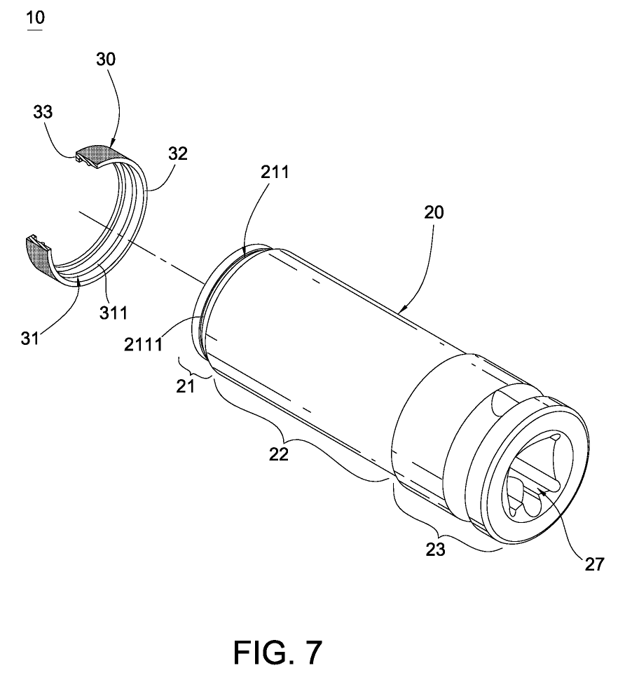

Please refer to FIGS. 2 to 13. The invention provides a rim bolt socket. A rim bolt socket 10 comprises a body 20 and a protective ring 30.

Firstly, please refer to FIGS. 2 to 13. Description of the body 20 is as follows.

The body 20 can be an integrally formed metal cylinder. The body 20 is axially provided with a protective section 21, a working section 22 coaxially connected to the protective section 21, and a driving section 23 coaxially connected to the working section 22. The protective section 21 and the driving section 23 are located at two axial ends of the body 20 respectively, and the working section 22 is located between the two axial ends of the body 20.

A length of the protective section 21 (taking an axial length as an example) is less than a length of the working section 22 (taking an axial length as an example). The length of the protective section 21 is less than one-eighth of the length of the working section 22, and a length of the driving section 23 is also less than the length of the working section 22. An outer diameter of the protective section 21 is less than an outer diameter of the working section 22, so that a connection between an outer peripheral wall of the protective section 21 and an outer peripheral wall of the working section 22 is formed with a first step 24. The outer diameter of the working section 22 is less than an outer diameter of the driving section 23, so that a connection between the outer peripheral wall of the working section 22 and an outer peripheral wall of the driving section 23 is formed with a second step 25. Thereby, the body 20 only sacrifices a wall thickness of a small area of the protective section 21 and maintains a wall thickness required for large areas of the working section 22 and the driving section 23 to withstand torsion.

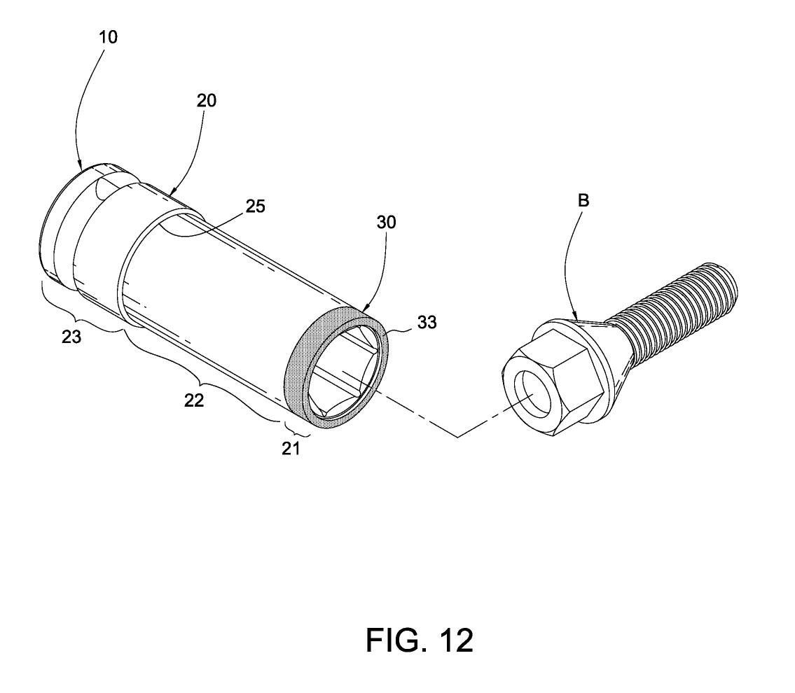

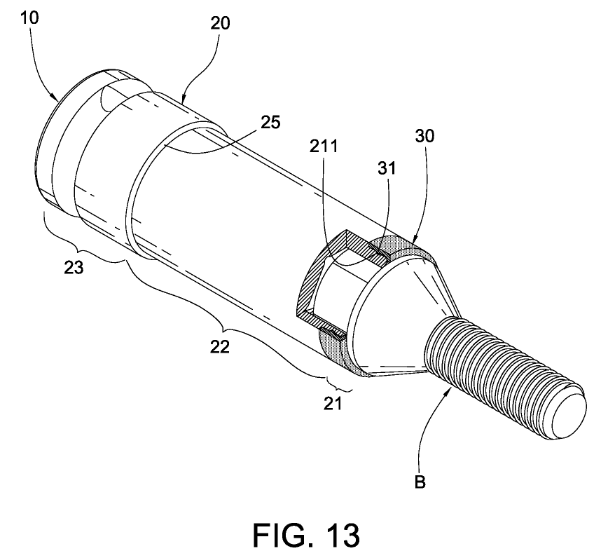

The body 20 is provided with a first actuating part 26 recessed on one end face of the protective section 21 along an axial direction of the body 20 toward the working section 22. The first actuating part 26 can be a hexagonal hole, but is not limited to a hexagonal hole. The body 20 uses the first actuating part 26 to combine with a rim bolt B (please refer to FIGS. 12 and 13) to be locked to a rim.

The body 20 is provided with a second actuating part 27 recessed on one end face of the driving section 23 along the axial direction of the body 20 toward the working section 22. The second actuating part 27 can be a quadrangular hole, but is not limited to a quadrangular hole. The body 20 uses the second actuating part 27 to combine with a hand tool to drive the body 20 to rotate. The hand tool can be an electric wrench, a pneumatic wrench or a manual wrench.

A first combination part 211 is formed on the outer peripheral wall between two ends of the protective section 21. The first combination part 211 can be recessed as a concave surface 2111, and the concave surface 2111 can be in the shape of a concave groove. When a number of the concave surface 2111 being one is used as an embodiment, forming in an annular continuous concave shape is adopted. When a number of the concave surface 2111 being more than one is used as an embodiment, forming annularly and concavely at intervals is adopted.

Then, please refer to FIGS. 2 to 13. Description of the protective ring 30 is as follows.

The protective ring 30 can be an integrally formed ring body made of plastic or silicone. A second combination part 31 is formed on an inner peripheral wall between two ends of the protective ring 30 along an axial direction. The second combination part 31 can be protruded as a convex surface 311 corresponding to the first combination part 211, and the convex surface 311 can be in the shape of a convex arc. When a number of the convex surface 311 being one is used as an embodiment, forming in an annular continuous convex shape is adopted. When a number of the convex surface 311 being more than one is used as an embodiment, forming annularly and convexly at intervals is adopted.

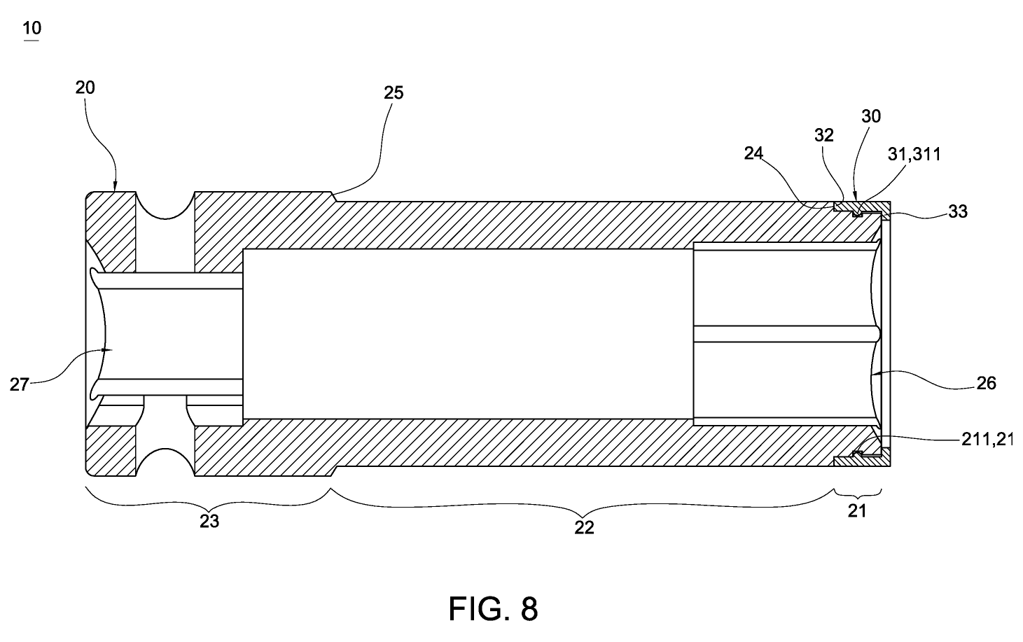

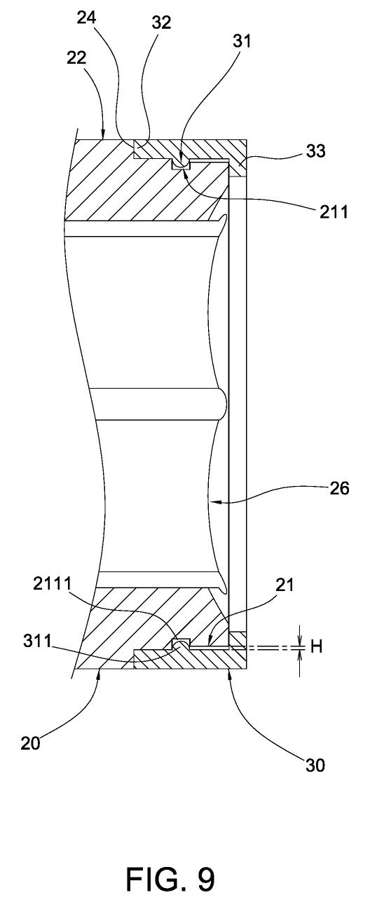

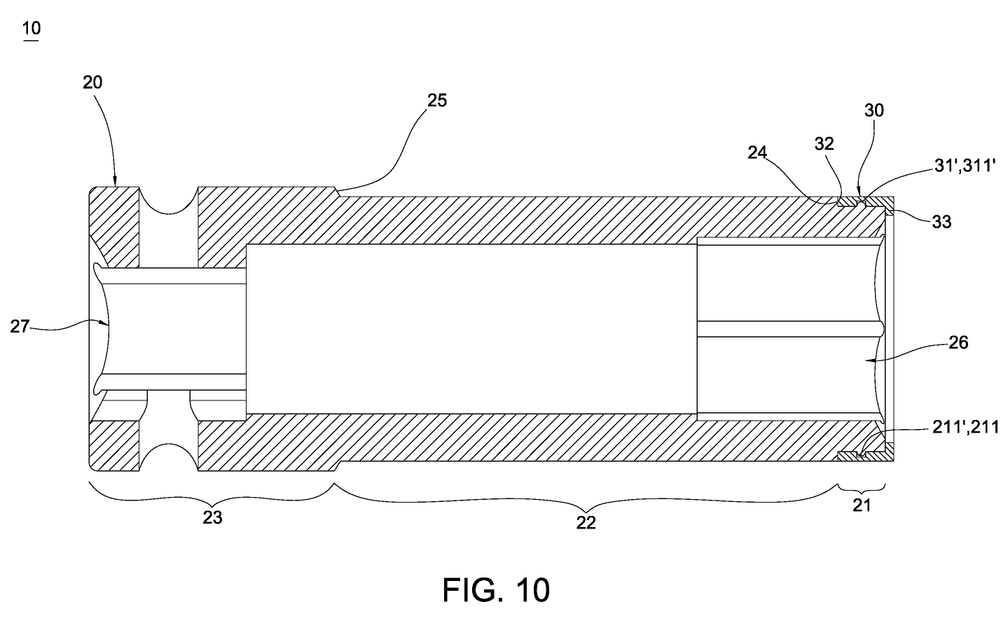

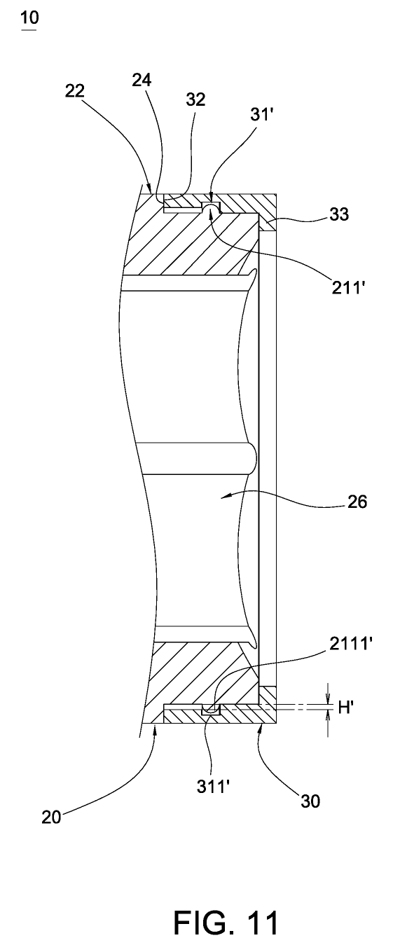

Contours of the concave surface 2111 of the first combination part 211 and the convex surface 311 of the second combination part 31 are formed correspondingly to each other so that they can be detachably combined. Due to the contours of the concave surface 2111 and the convex surface 311 being formed correspondingly to each other, if requirements of withstanding torsion can be met, the concave surface 2111 of the first combination part 211 and the convex surface 311 of the second combination part 31 can be interchanged with each other. Therefore, the concave surface 2111 of the first combination part 211 (please refer to FIGS. 8 and 9) can be replaced by a convex surface 2111' of a first combination part 211' (please refer to FIGS. 10 and 11); and the convex surface 311 of the second combination part 31 (please refer to FIGS. 8 and 9) can be replaced by a concave surface 311' of a second combination part 31' (please refer to FIGS. 10 and 11). If requirements of withstanding torsion can be met, the concave surface 2111 matching the convex surface 311 and the convex surface 2111' matching the concave surface 311' can even be replaced by equivalent structures.

An outer end wall of one axial end of the protective ring 30 is protruded with a first stopper 32 along the axial direction of the protective ring 30, and the inner peripheral wall of another axial end of the protective ring 30 is protruded with a second stopper 33 along a radial direction of the protective ring 30.

An outer diameter of an outer peripheral wall of one side of the first combination part 211 of the protective section 21 away from the working section 22 is less than an outer diameter of an outer peripheral wall of another side of the first combination part 211 close to the working section 22, thereby forming a height difference H (please refer to FIG. 9). Thereby facilitating the second combination part 31 of the protective ring 30 to utilize the height difference H to easily separate from the first combination part 211 of the protective section 21.

In addition, when the convex surface 2111' of the first combination part 211' (please refer to FIGS. 10 and 11) matches the concave surface 311' of the second combination part 31' (please refer to FIGS. 10 and 11), an inner diameter of an inner peripheral wall of one side of the second combination part 31' of the protective ring 30 adjacent to the first stopper 32 is larger than an inner diameter of an inner peripheral wall of another side of the second combination part 31' adjacent to the second stopper 33, thereby also forming another height difference H' (please refer to FIG. 11). Thereby facilitating the first combination part 211' of the protective section 21 to utilize the height difference H' to easily separate from the second combination part 31' of the protective ring 30.

The protective ring 30 is sleeved on the protective section 21 of the body 20. The concave surface 2111 of the first combination part 211 (please refer to FIGS. 8 and 9) is combined with the convex surface 311 of the second combination part 31, or the convex surface 2111' of the first combination part 211 (please refer to FIGS. 10 and 11) is combined with the concave surface 311' of the second combination part 31, so that the first stopper 32 butts against a step wall of the first step 24 of the adjacent protective section 21. In addition, the second stopper 33 butts against an outer end wall of the protective section 21. When the rim bolt socket 10 is combined with the rim bolt B, the body 20 butts against the rim bolt B through the second stopper 33 of the protective ring 30 to protect each other.

An outer diameter of the protective ring 30 and the outer diameter of the working section 22 of the body 20 can be equal to each other, so that an outer peripheral wall of the protective ring 30 and the outer peripheral wall of the working section 22 of the body 20 are flushed with each other to facilitate disassembly and assembly operations. Without affecting the disassembly and assembly operations, the outer diameters can also be unequal, so that the outer peripheral walls are not flushed with each other.

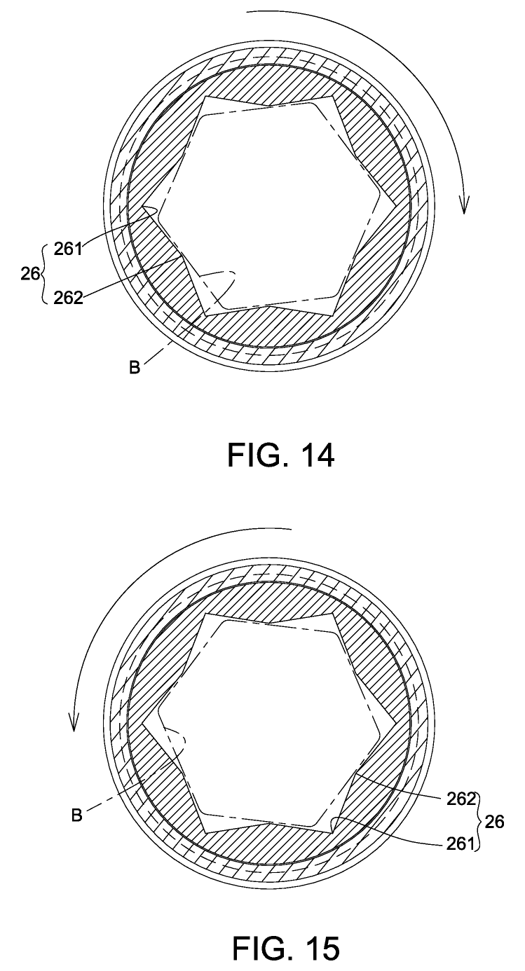

In addition to using the common hexagonal hole of the socket in the aforementioned embodiment, the first actuating part 26 of the body 20 can also be further annularly provided with a plurality of first concave portions 261 and a plurality of first convex portions 262 on an inner peripheral wall (please refer to FIGS. 14 and 15). A first included angle is provided between any two adjacent concave surfaces of each of the first concave portions 261, and a second included angle is provided between any two adjacent convex surfaces of each of the first convex portions 262, any one of the first concave portions 261 is provided between any two of the first convex portions 262, so that two sides of any one of the first concave portions 261 are respectively connected to one side of any two of the first convex portions 262, and numbers of the first concave portions 261 and the first convex portions 262 are equal in one of the embodiments. Thereby, when the rim bolt socket 10 tightens or loosens the rim bolt B, a contact area between the first actuating part 26 of the body 20 and the rim bolt B becomes larger, and the first convex portions 262 contact flat parts of a hexagonal column in the rim bolt B to reduce a chance of wear or chipping of corners of the hexagonal column, so that the first actuating part 26 is less likely to slip with the rim bolt B. Each of the first concave portions 261 can also be an arc-shaped depression to match an arc-shaped protrusion of each of the first convex portions 262. A spacing between each of the first convex portions 262 is greater than a spacing between each of the first concave portions 261, which also increases a contact area between the first actuating part 26 of the body 20 and the rim bolt B and it is less likely to slip.

The invention provides the rim bolt socket 10. Considering a high chance of collision between an end of the body 20 and a rim, the body 20 only sacrifices a wall thickness of the protective section 21 and maintains a wall thickness required for the working section 22 and the driving section 23 to withstand torsion. Thereby, a load-bearing capacity of the body 20 is greatly improved, and even under an impact of a hand tool, the body 20 can be prevented from being cracked and resulting in ruptures.

The invention provides the rim bolt socket 10, wherein the protective section 21 of the body 20 itself has the protective ring 30; thereby, the rim bolt socket 10 is capable of directly performing disassembly and assembly of loosening or tightening the rim bolt B, which is convenient and fast.

The invention provides the rim bolt socket 10, wherein the protective section 21 of the body 20 itself is under an action of the protective ring 30. Thereby, the body 20 is protected during disassembly and assembly processes, and collision between the body 20 and a rim is prevented from damaging the rim.

Descriptions of "first" and "second" mentioned in this invention are for distinction and do not represent a sequence.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A rim bolt socket comprising:
a body, the body being provided with a protective section, a working section connected to the protective section, and a driving section connected to the working section, a connection between an outer peripheral wall of the protective section and an outer peripheral wall of the working section being formed with a first step, and a first combination part being formed on the outer peripheral wall of the protective section; and
a protective ring, the protective ring being sleeved on the protective section of the body, a second combination part being formed on an inner peripheral wall of the protective ring to be combined with the first combination part, and a first stopper being provided at one end of the protective ring to butt against the first step.

2. The rim bolt socket as claimed in claim 1, wherein the body is an integrally formed metal cylinder, the body is axially provided with the protective section, the working section coaxially connected to the protective section, and the driving section coaxially connected to the working section.

3. The rim bolt socket as claimed in claim 1, wherein a length of the protective section is less than a length of the working section, the length of the protective section is less than one-eighth of the length of the working section, an outer diameter of the protective section is less than an outer diameter of the working section, the outer diameter of the working section is less than an outer diameter of the driving section, so that a connection between the outer peripheral wall of the working section and an outer peripheral wall of the driving section is formed with a second step.

4. The rim bolt socket as claimed in claim 1, wherein the body is provided with a first actuating part recessed on one end face of the protective section along an axial direction of the body toward the working section, the first actuating part is a hexagonal hole, the body is provided with a second actuating part recessed on one end face of the driving section along the axial direction of the body toward the working section, the second actuating part is a quadrangular hole, the first actuating part of the body is annularly provided with a plurality of first concave portions and a plurality of first convex portions on an inner peripheral wall, a first included angle is provided between any two adjacent concave surfaces of each of the first concave portions, a second included angle is provided between any two adjacent convex surfaces of each of the first convex portions, any one of the first concave portions is provided between any two of the first convex portions, two sides of any one of the first concave portions are respectively connected to one side of any two of the first convex portions, and numbers of the first concave portions and the first convex portions are equal.

5. The rim bolt socket as claimed in claim 1, wherein the first combination part of the protective section is protruded as a convex surface or recessed as a concave surface, the second combination part of the protective ring is recessed as a concave surface or protruded as a convex surface corresponding to the first combination part, the concave surface is in the shape of a concave groove, the convex surface is in the shape of a convex arc, and the convex surface or the concave surface of the first combination part is combined with the concave surface or the convex surface of the second combination part.

6. The rim bolt socket as claimed in claim 1, wherein the protective ring is an integrally formed ring body made of plastic or silicone.

7. The rim bolt socket as claimed in claim 1, wherein an outer end wall of one axial end of the protective ring is protruded with the first stopper along an axial direction of the protective ring to butt against a step wall of the first step of the adjacent protective section, and the inner peripheral wall of another axial end of the protective ring is protruded with a second stopper along a radial direction of the protective ring to butt against an outer end wall of the protective section.

8. The rim bolt socket as claimed in claim 1, wherein an outer diameter of an outer peripheral wall of one side of the first combination part of the protective section away from the working section is less than an outer diameter of an outer peripheral wall of another side of the first combination part close to the working section, thereby forming a height difference.

9. The rim bolt socket as claimed in claim 7, wherein an inner diameter of an inner peripheral wall of one side of the second combination part of the protective ring adjacent to the first stopper is larger than an inner diameter of an inner peripheral wall of another side of the second combination part adjacent to the second stopper, thereby forming a height difference.

10. The rim bolt socket as claimed in claim 1, wherein the first combination part is formed on the outer peripheral wall between two ends of the protective section, the second combination part is formed on the inner peripheral wall between two ends of the protective ring, an outer diameter of the protective ring and the outer diameter of the working section of the body are equal to each other, an outer peripheral wall of the protective ring and the outer peripheral wall of the working section of the body are flushed with each other.
